(19) United States
(12) Patent Application Publication
(10) Pub. No.: US 2024/0039039 A1
(43) Pub. Date: Feb. 1, 2024

(54) TITANIC ACID-BASED SOLID ELECTROLYTE MATERIAL

(71) Applicant: OTSUKA CHEMICAL CO., LTD., Osaka-city, Osaka (JP)

(72) Inventors: Mizuki Ito, Tokushima-city, Tokushima (JP); Hiroyoshi Mori, Tokushima-city, Tokushima (JP)

(73) Assignee: OTSUKA CHEMICAL CO., LTD., Osaka-city, Osaka (JP)

(21) Appl. No.: 18/039,854

(22) PCT Filed: Nov. 15, 2021
(86) PCT No.: PCT/JP2021/041833

§ 371 Date: Jun. 1, 2023

(30) Foreign Application Priority Data
Dec. 4, 2020 (JP) 2020-201788

(51) Int. Cl. H01M 10/0562; H01M 10/0525

(52) U.S. Cl. CPC H01M 10/0562; H01M 10/0525; H01M 2300/0074

(57) ABSTRACT

Provided is a titanic acid-based solid electrolyte material free from risk of production of hydrogen sulfide, free of rare earth, and having good lithium-ion conductivity. The titanic acid-based solid electrolyte material is made of a lepidocrocite titanate having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, and titanium sites in the host layers are partially substituted by cations with valences of +1 to +3.

### TECHNICAL FIELD

The present invention relates to titanic acid-based solid electrolyte materials.

### BACKGROUND ART

Lithium-ion secondary batteries are secondary batteries that are composed of a positive electrode, a negative electrode, a separation film preventing physical contact between the positive electrode and the negative electrode, and an electrolyte and perform charging and discharging by migration of lithium ions through the electrolyte between the positive electrode and the negative electrode. The lithium-ion secondary batteries are used as power sources for notebook personal computers, tablet terminals, and smartphones because they have excellent energy density and power density and are effective in size reduction and weight reduction. These batteries are also attracting attention as power sources for electric vehicles.

A conventional electrolyte used in such batteries is an electrolytic solution containing a flammable organic solvent. Therefore, liquid leakage is likely to occur and excessive charging or discharging may cause short circuit inside the batteries and thus cause ignition of the batteries. In view of this, in order to improve safety, all-solid-state lithium-ion secondary batteries have recently been researched and developed in which an inorganic solid electrolyte material is used instead of an electrolytic solution.

Inorganic solid electrolyte materials for use in all-solid-state lithium-ion secondary batteries are classified, based on whether the principal element forming the skeleton is an oxygen atom or a sulfur atom, into two types: sulfide-based solid electrolyte materials and oxide-based solid electrolyte materials. Sulfide-based solid electrolyte materials show high lithium-ion conductivity compared to oxide-based solid electrolyte materials, but have high reactivity with moisture and therefore have safety problems, such as production of hydrogen sulfide. For this reason, consideration has been made of methods for improving the lithium-ion conductivity of oxide-based solid electrolyte materials, such as (La, Li)TiO₃ (hereinafter, referred to as “LLTO”), Li₆La₂CaTa₂O₁₂, Li₆La₂ANb₂O₁₂ (A=Ca, Sr), and Li₂Nd₃TeSbO₁₂. For example, a method of doping LLTO with 1% to 5% by mass sulfur is disclosed (see Patent Literature 1).

### CITATION LIST

### Patent Literature

Patent Literature 1: JP-A-2018-73805

### SUMMARY OF INVENTION

### Technical Problem

However, the oxide-based solid electrolyte material in Patent Literature 1 contains sulfur and, therefore, may produce hydrogen sulfide. In addition, rare earth is used in the material, which causes concern about production cost.

An object of the present invention is to provide a titanic acid-based solid electrolyte material free from risk of production of hydrogen sulfide, free of rare earth, and having good lithium-ion conductivity, a method for producing the titanic acid-based solid electrolyte material, and a solid electrolyte and a lithium-ion secondary battery in each of which the titanic acid-based solid electrolyte material is used.

### Solution to Problem

The present invention provides the following titanic acid-based solid electrolyte material, method for producing the same, solid electrolyte, and lithium-ion secondary battery.

Aspect 1: A titanic acid-based solid electrolyte material made of a lepidocrocite titanate having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by cations with valences of +1 to +3.

Aspect 2: The titanic acid-based solid electrolyte material according to aspect 1, wherein an interlayer distance between the host layers is not less than 5 Å and not more than 10 Å.

Aspect 3: The titanic acid-based solid electrolyte material according to aspect 1 or 2, wherein the lepidocrocite titanate contains crystallization water.

Aspect 4: The titanic acid-based solid electrolyte material according to any one of aspects 1 to 3, wherein a content of the lithium ions present in the interlayers between the host layers is not less than 45% by mole and not more than 100% by mole relative to 100% by mole of ions present in the interlayers between the host layers.

Aspect 5: The titanic acid-based solid electrolyte material according to any one of aspects 1 to 4, being at least one of a compound represented by general formula (1) below and a compound represented by general formula (2) below:

LiₓM^{I}_{Y}T_{1.73}O_{3.7-4}·nH₂O Formula (1)
where M^{I} represents an alkali metal except for lithium, the index x is 0.3 to 1.0, the index y is 0 to 0.4, and the index n is 0 to 2; and

LiₓM^{I}_{Y}M^{II}_{z}Ti_{1.6}O_{3.7-4}·nH₂O Formula (2)
where M^{I} represents an alkali metal except for lithium, M^{II} represents an alkaline earth metal, the index x is 0.3 to 1.0, the index y is 0 to 0.4, the index z is 0 to 0.4, and the index n is 0 to 2.

Aspect 6: A method for producing the titanic acid-based solid electrolyte material according to any one of aspects 1 to 5, the method including the step of subjecting a lepidocrocite titanate and a lithium salt to mixing and heat treatment.

Aspect 7: A method for producing the titanic acid-based solid electrolyte material according to any one of aspects 1 to 5, the method including the steps of: mixing a lepidocrocite titanate and an acid to prepare a lepidocrocite titanic acid; and mixing the lepidocrocite titanic acid and a lithium salt.

Aspect 8: A solid electrolyte containing the titanic acid-based solid electrolyte material according to any one of aspects 1 to 5.

Aspect 9: A lithium-ion secondary battery including the solid electrolyte according to aspect 8.

### Advantageous Effects of Invention

The present invention enables provision of a titanic acid-based solid electrolyte material free from risk of production of hydrogen sulfide, free of rare earth, and having good lithium-ion conductivity. With the use of a solid electrolyte containing the above titanic acid-based solid electrolyte material, a high-power battery having excellent safety can be obtained.

### BRIEF DESCRIPTION OF DRAWINGS

FIG. 1 is a schematic view showing a titanic acid-based solid electrolyte material according to one embodiment of the present invention.

FIG. 2 is a schematic cross-sectional view showing a lithium-ion secondary battery according to one embodiment of the present invention.

FIG. 3 is Nyquist diagrams of Examples 1 to 4 and Comparative Example 1.

FIG. 4 is Nyquist diagrams of Examples 1, 5, and 6.

### DESCRIPTION OF EMBODIMENTS

Hereinafter, a description will be given of an example of a preferred embodiment for working of the present invention. However, the following embodiment is simply illustrative. The present invention is not at all limited by the following embodiment.

<Titanic Acid-Based Solid Electrolyte Material>

A titanic acid-based solid electrolyte material according to the present invention is made of a lepidocrocite titanate having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by cations with valences of +1 to +3. The lepidocrocite titanate may or may not contain crystallization water in the interlayers between the host layers and/or other sites. Preferably, the lepidocrocite titanate contains crystallization water in the interlayers between the host layers and/or other sites.

The host layer is formed so that octahedra each formed of a titanium atom coordinated with six oxygen atoms are two-dimensionally chained while sharing ridges, and forms a single layer serving as a unit of the layered structure (laminate). The individual host layers are originally electrically neutral, but are negatively charged since their tetravalent titanium sites are partially substituted by cations with valences of +1 to +3 or are partially vacant. The negative charges of the host layers are compensated for by positive charges of lithium ions or so on present between one host layer and another (hereinafter, referred to as “in the interlayers”), which ensures the electrical neutrality of this compound.

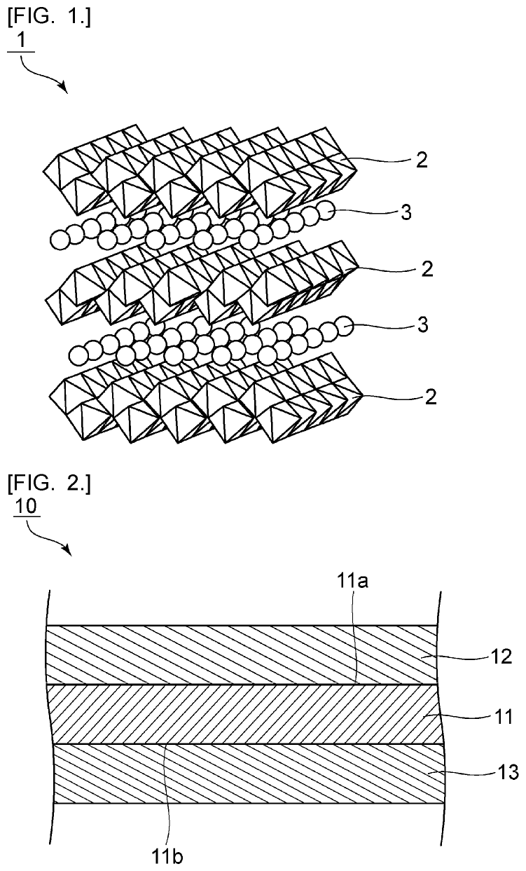

More specifically, FIG. 1 is a schematic view showing a titanic acid-based solid electrolyte material according to an embodiment of the present invention. As shown in FIG. 1, the titanic acid-based solid electrolyte material 1 has a crystal structure in which a plurality of host layers 2 are laid one on top of another and ions 3, such as lithium ions, are intercalated in the interlayers between the host layers 2. The individual host layer 2 is formed so that octahedra each formed of a titanium atom coordinated with six oxygen atoms are two-dimensionally chained while sharing ridges. FIG. 1 is a schematic view shown as an example and the titanic acid-based solid electrolyte material according to the present invention is not limited to the structure in the schematic view of FIG. 1.

In relation to the host layer, from the viewpoint of further increasing the lithium-ion conductivity, more than 0% by mole and not more than 40% by mole of the titanium sites in the host layer are preferably substituted by cations with valences of +1 to +3. Examples of the cation include a hydrogen ion, an oxonium ion, an alkali metal ion, an alkaline earth metal ion, a zinc ion, a nickel ion, a copper ion, an iron ion, an aluminum ion, a gallium ion, and a manganese ion. From the viewpoint of further increasing the lithium-ion conductivity, at least one selected from the group consisting of a hydrogen ion, an oxonium ion, a lithium ion, and a magnesium ion is preferred and a lithium ion or a magnesium ion is more preferred.

The titanium sites in the host layer may be partially vacant. When the titanium sites have vacancies, more than 0% by mole and not more than 15% by mole of the titanium sites in the host layer are preferably vacant from the viewpoint of further increasing the lithium-ion conductivity.

The interlayer distance between the host layers of the lepidocrocite titanate making up the titanic acid-based solid electrolyte material is preferably not less than 5 Å, more preferably not less than 6 Å, preferably not more than 10 Å, more preferably not more than 9 Å, and still more preferably not more than 7 Å. The lepidocrocite titanate has a layered structure in its crystal structure and its interlayers form two-dimensional conduction paths for lithium ions, which provides the lithium-ion conductivity. It can be considered that by defining the interlayer distance within the above range, the lithium ion density in the interlayers can be increased, which makes the activation energy for ion conduction smaller and thus makes the lithium ion conductivity better.

In an X-ray diffraction pattern of the material, several peaks appearing at equal intervals in a low angle range (approximately 2θ=200 or less) are derived from the layered structure of titanic acid. The interlayer distance can be calculated from the diffraction angle (2θ) of the primary peak appearing at the lowest angle. Specifically, the interlayer distance can be calculated using the Bragg's equation “d=nλ/2 sin θ” (where d is the interlayer distance (Angstrom), θ is a value obtained by dividing the diffraction angle (2θ) of the primary peak by 2, λ is a wavelength of the CuKα rays of 1.5418 Å, and n is a positive integer (n=1 for the primary peak)).

Lithium ions only may be intercalated in the interlayers between the host layers. Alternatively, in addition to lithium ions, hydrogen ions, oxonium ions, alkali metal ions, alkaline earth metal ions or so on may be intercalated without impairing preferred physical properties of the present invention and at least one type of ions selected from the group consisting of hydrogen ions, oxonium ions, potassium ions, and sodium ions are preferably intercalated from the viewpoint of further increasing the lithium ion conductivity. In addition to lithium ions, potassium ions or sodium ions are more preferably intercalated in the interlayers between the host layers. The content of lithium ions present in the interlayers between the host layers is, from the viewpoint of further increasing the lithium-ion conductivity, preferably not less than 45% by mole, more preferably not less than 60% by mole, still more preferably not less than 80% by mole, preferably not more than 100% by mole, and more preferably not more than 90% by mole relative to 100% by mole of ions present in the interlayers between the host layers.

The lepidocrocite titanate making up the titanic acid-based solid electrolyte material is formed of powdered particles, including spherical particles (inclusive of particles of a spherical shape with some asperities on its surface and particles of an approximately spherical shape, such as those having an elliptic cross-section), bar-like particles (inclusive of particles of an approximately bar-like shape as a whole, such as rodlike, columnar, prismoidal, reed-shaped, approximately columnar, and approximately reed-shaped particles), platy particles, blocky particles, particles of a shape with multiple projections (such as amoeboid, boomerang-like, cross, or kompeito-like shape), and particles of an irregular shape. The size of the particles is not particularly limited, but the average particle diameter is preferably 0.01 μm to 20 μm, more preferably 0.05 μm to 10 μm, and still more preferably 0.1 μm to 5 μm.

The “average particle diameter” herein refers to a particle diameter at a volume-based cumulative integrated value of 50% in a particle size distribution determined by the laser diffraction and scattering method (a volume-based 50% cumulative particle diameter), i.e., D₅₀ (a median diameter). This volume-based 50% cumulative particle diameter (D₅₀) is a particle diameter at a cumulative value of 50% in a cumulative curve of a particle size distribution determined on a volume basis, the cumulative curve assuming the total volume of particles to be 100%, where during accumulation the number of particles is counted from a smaller size side. These various types of particle shapes and particle sizes can be arbitrarily controlled depending on the shape of a lepidocrocite titanate as a source material to be described hereinafter.

The lepidocrocite titanate thus far described is preferably at least one compound of a compound represented by the general formula (1) below and a compound represented by the general formula (2) below, more preferably at least one compound selected from the group consisting of Li_{0.3-1.1}K_{0-0.1}Na_{0-0.5}Ti_{1.73}O_{3.7-4}·0-2H₂O, Li_{0.3-1.1}K_{0-0.5}Ti_{1.73}O_{3.7-4}·0-2H₂O, and Li_{0.3-1.6}K_{0-0.1}Mg_{0-0.4}Ti_{1.6}O_{3.7-4}·0-2H₂O, still more preferably at least one compound selected from the group consisting of Li_{0.5-1.1}K_{0-0.1}Na_{0-0.5}Ti_{1.73}O₄·0-2H₂O, Li_{0.5-1.1}K_{0-0.1}Ti_{1.73}O₄·0-2H₂O, and Li_{0.5-1.6}K_{0-0.1}Mg_{0-0.4}Ti_{1.6}O₄·0-2H₂O, and particularly preferably at least one compound selected from the group consisting of Li_{0.5-1.1}K_{0-0.1}Ti_{1.73}O₄·0.1-2H₂O and Li_{0.5-1.6}K_{0-0.1}Mg_{0-0.4}Ti_{1.6}O₄·0.1-2H₂O.

LiₓM^{I}_{Y}Ti_{1.73}O_{3.7-4}·nH₂O Formula (1)
where M^{I} represents an alkali metal except for lithium, the index x is 0.3 to 1.1, the index y is 0 to 0.4, and the index n is 0 to 2; and

LiₓM^{I}_{Y}M^{II}_{z}Ti_{1.6}O_{3.7-4}·nH₂O Formula (2)
where M^{I} represents an alkali metal except for lithium, M^{II} represents an alkaline earth metal, the index x is 0.3 to 1.6, the index y is 0 to 0.4, the index z is 0 to 0.4, and the index n is 0 to 2.

The index x in the general formula (1) is 0.3 to 1.1, preferably 0.5 to 1.1, and more preferably 0.7 to 1.1. The index x in the general formula (2) is 0.3 to 1.6, preferably 0.5 to 1.6, and more preferably 0.7 to 1.1.

The index y in the general formula (1) is 0 to 0.4, preferably 0.05 to 0.35, and more preferably 0.05 to 0.1. The index y in the general formula (2) is 0 to 0.4 and preferably 0.01 to 0.1.

The index z in the general formula (2) is 0 to 0.4 and preferably 0.2 to 0.35.

The index n in the general formula (1) is 0 to 2 and preferably 0.1 to 2. The index n in the general formula (2) is 0 to 2 and preferably 0.1 to 2.

Because the titanic acid-based solid electrolyte material according to the present invention has excellent lithium-ion conductivity and is free of sulfur, it can be suitably used as a solid electrolyte material for a lithium-ion secondary battery. In addition, the titanic-acid solid electrolyte material according to the present invention is free from risk of production of hydrogen sulfide since it is free of sulfur, and it is excellent in production cost because of no use of rare earth.

(Method for Producing Titanic Acid-Based Solid Electrolyte Material)

The method for producing the titanic acid-based solid electrolyte material according to the present invention is not limited to any particular production method so long as the above-described composition can be obtained, and an example is a production method of allowing a lithium salt to act on a lepidocrocite titanate or a lepidocrocite titanic acid.

The production method of allowing a lithium salt to act on a lepidocrocite titanate includes the step (I) of subjecting a lepidocrocite titanate as a source material and a lithium salt to mixing and heat treatment. During the mixing in the step (I), a potassium salt or a sodium salt is preferably further mixed from the viewpoint of further increasing the lithium-ion conductivity.

In the step (I), examples of the lepidocrocite titanate as a source material (hereinafter, referred to also simply as a “source titanate”) include AₓM_{y}Ti_{(2-y)}O₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0], A_{0.5-0.7}Li_{0.27}Ti_{1.73}O_{3.85-3.95} [where A is at least one of alkali metals except for Li], A_{0.2-0.7}Mg_{0.40}Ti_{1.6}O_{3.7-3.95} [where A is at least one of alkali metals except for Li], and A_{0.5-0.7} Li_{(0.27-x)}M_{y}Ti_{(1.73-z)}O_{3.85-3.95} [where: A is at least one of alkali metals except for Li; M is at least one selected from among Mg, Zn, Ga, Ni, Cu, Fe, Al, and Mn (except for combinations of different types of ions having different valences in using two or more types of ions); x=2y/3 and z=y/3 when M is a divalent metal; x=y/3 and z=2y/3 when M is a trivalent metal; and 0.004≤y≤0.4], and the preferred lepidocrocite titanate is at least one selected from the group consisting of A_{0.5-0.7} Li_{0.27}Ti_{1.73}O_{3.85-3.95} [where A is at least one of alkali metals except for Li] and A_{0.2-0.7}Mg_{0.40}Ti_{1.6}O_{3.7-3.95} [where A is at least one of alkali metals except for Li].

The lithium salt for use in the step (I) is not limited so long as it has a lower melting point than the source titanate and can be melted at the heat treatment temperature in the step (I), examples include lithium nitrate, lithium chloride, lithium sulfate, and lithium carbonate, and the preferred lithium salt is lithium nitrate.

In the use of a sodium salt in the step (I), the sodium salt is not limited so long as it has a lower melting point than the source titanate and can be melted at the heat treatment temperature in the step (I), and an example is sodium nitrate.

In the use of a potassium salt in the step (I), the potassium salt is not limited so long as it has a lower melting point than the source titanate and can be melted at the heat treatment temperature in the step (I), and an example is potassium nitrate.

The amount of lithium salt mixed, the amount of salt compound of a lithium salt and a potassium salt mixed or the amount of salt compound of a lithium salt and a sodium salt mixed is preferably 10 to 30 equivalents relative to the volume of exchangeable cations in the source titanate. If the amount is less than 10 equivalents, sufficient ion exchange cannot be expected. If the amount is more than 30 equivalents, this is economically inadvisable. The term “volume of exchangeable cations” refers to, for example, a value represented by x when a layered titanate is represented by the general formula AₓM_{y}Ti_{(2-y)} O₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0].

When in the step (I) a source titanate and a lithium salt, a salt compound of a lithium salt and a potassium salt or a salt compound of a lithium salt and a sodium salt are subjected to mixing and heat treatment, the source titanate reacts with the lithium salt or the salt compound as the layered structure of the source titanate is maintained, thus producing a lepidocrocite titanate making up the solid electrolyte material according to the present invention. The above mixing is preferably conducted under a dry condition and an example of the heat treatment condition is 24 hours to 72 hours in a temperature range of 250° C. to 350° C. and preferably a temperature range of 250° C. to 300° C. After the heat treatment, it is preferred to wash off the salt compound as a flux component with deionized water and dry the remaining material to produce a lepidocrocite titanate making up the solid electrolyte material according to the present invention.

The production method of allowing a lithium salt to act on a lepidocrocite titanic acid includes: the step (II) of mixing a lepidocrocite titanate as a source material and an acid to prepare a lepidocrocite titanic acid; and the step (III) of mixing the lepidocrocite titanic acid prepared in the step (II) and a lithium salt. During the mixing in the step (III), a potassium salt or a sodium salt is preferably further mixed from the viewpoint of further increasing the lithium-ion conductivity.

In the step (II), the source titanate is mixed with the acid (subjected to acid treatment). The acid treatment is preferably conducted under a wet condition. By this acid treatment, cations, such as metal ions by which some of the titanium sites in the host layers has been substituted and metal ions between the host layers, are substituted by hydrogen ions or hydronium ions as the layered structure of the source titanate is maintained, and, as a result, a lepidocrocite titanic acid can be produced. The term titanic acid used here includes a hydrated titanic acid in which water molecules are present in the interlayers.

The acid for use in the step (II) is not particularly limited and may be a mineral acid, such as hydrochloric acid, sulfuric acid, nitric acid, phosphoric acid or boric acid, or an organic acid. The acid treatment can be performed, for example, by mixing an acid into an aqueous slurry of a source titanate and the treatment temperature is preferably 5° C. to 80° C. The cation exchange rate can be controlled by appropriately adjusting the type and concentration of the acid and the concentration of the source titanate slurry according to the type of the source titanate, but is preferably 70% to 100% relative to the volume of exchangeable cations in the source titanate from the viewpoint of the interlayer distance of the resultant lepidocrocite titanate. The term “volume of exchangeable cations” refers to, for example, a value represented by x+my when a layered titanate is represented by the general formula AₓM_{y}Ti_{(2-y)}O₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0] and m represents the valence of M.

When in the step (III) the lepidocrocite titanic acid prepared in the step (II) is mixed with a lithium salt (subjected to lithiumization treatment), the lithium salt reacts by ion exchange with hydrogen ions, hydronium ions, and so on in the interlayers. In the lithiumization treatment, a potassium salt or a sodium salt is preferably further mixed from the viewpoint of further increasing the lithium-ion conductivity. The lithiumization treatment is preferably conducted under a wet condition. When, after the lithiumization treatment, the mixture is dried to remove the solvent, such as water, a lepidocrocite titanate making up the solid electrolyte material according to the present invention can be produced. After the step (III), the product may be further subjected to heat treatment. An example of the heat treatment condition is 0.5 hours to 5 hours in a temperature range of 200° C. to 400° C.

The lithium salt for use in the step (III) is not limited so long as it can introduce lithium ions into the interlayers of the lepidocrocite titanic acid, examples include lithium hydroxide monohydrate, lithium carbonate, lithium acetate, lithium citrate, lithium chloride, lithium nitrate, lithium sulfate, lithium phosphate, lithium bromide, lithium iodide, lithium tetraborate, LiPF₆, and LiBF₄, and the preferred lithium salt is lithium hydroxide monohydrate.

In the use of a sodium salt in the step (III), the sodium salt is not limited so long as it can introduce sodium ions into the interlayers of the lepidocrocite titanic acid, examples include sodium hydroxide, sodium carbonate, sodium acetate, sodium citrate, sodium chloride, sodium nitrate, sodium sulfate, sodium phosphate, sodium bromide, sodium iodide, sodium tetraborate, NaPF₆, and NaBF₄, and the preferred sodium salt is sodium hydroxide. These sodium salts may be used singly or in combination of two or more of them.

In the use of a potassium salt in the step (III), the potassium salt is not limited so long as it can introduce potassium ions into the interlayers of the lepidocrocite titanic acid, examples include potassium hydroxide, potassium carbonate, potassium acetate, potassium citrate, potassium chloride, potassium nitrate, potassium sulfate, potassium phosphate, potassium bromide, potassium iodide, potassium tetraborate, KPF₆, and KBF₄, and the preferred potassium salt is potassium hydroxide. These potassium salts may be used singly or in combination of two or more of them.

In allowing a lithium salt, a salt compound of a lithium salt and a potassium salt or a salt compound of a lithium salt and a sodium salt to act on the lepidocrocite titanic acid in the step (III), a suspension containing the lepidocrocite titanic acid dispersed into water or an aqueous medium is mixed directly with the lithium salt or the salt compound or mixed with a dilution of the lithium salt or the salt compound with water or an aqueous medium, and the mixture is stirred. The amount of lithium salt or salt compound mixed is preferably 0.2 to 3 equivalents of lithium salt or salt compound and more preferably 1 to 2 equivalents of lithium salt or salt compound relative to the volume of exchangeable cations in the lepidocrocite titanic acid. If the amount is less than 0.2 equivalents, sufficient ion exchange cannot be expected. If the amount is more than 3 equivalents, this is economically inadvisable. The term “volume of exchangeable cations” refers to, for example, a value represented by x+my when a layered titanate is represented by the general formula AₓM_{y}Ti_{(2-y)}O₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0] and m represents the valence of M.

<Solid Electrolyte>

A solid electrolyte according to the present invention is a solid electrolyte comprising the above-described titanic acid-based solid electrolyte material and is a layer free of flammable organic solvent and capable of conducting lithium ions.

The proportion of the solid electrolyte material contained in the solid electrolyte is preferably 10% by volume to 100% by volume and more preferably 50% by volume to 100% by volume relative to a total amount of the solid electrolyte of 100% by volume. The solid electrolyte may contain a binder that binds particles of the solid electrolyte material together.

The thickness of the solid electrolyte is preferably 0.1 μm to 1000 μm and more preferably 0.1 μm to 300 μm.

Examples of the method for forming a solid electrolyte include a method of sintering a solid electrolyte material and a method of producing a solid electrolyte sheet containing a binder. The materials that can be used as the binder are the same materials as described as binders for use in a positive electrode and a negative electrode to be described hereinafter. The temperature of the sintering is preferably set to be lower than the heat treatment temperature during production of the solid electrolyte material in order to prevent the crystal structure of the solid electrolyte material from changing during sintering.

Because the solid electrolyte according to the present invention has excellent lithium-ion conductivity and is free of sulfur, it can be suitably used as a solid electrolyte for a lithium-ion secondary battery. In addition, the solid electrolyte according to the present invention is free from risk of production of hydrogen sulfide since it is free of sulfur, and it is excellent in production cost because of no use of rare earth.

<Battery>

A battery according to the present invention is a lithium-ion secondary battery which includes a positive electrode, a negative electrode, and a solid electrolyte disposed between the positive electrode and the negative electrode and in which the solid electrolyte contains the titanic acid-based solid electrolyte material according to the present invention, i.e., an all-solid-state battery.

More specifically, FIG. 2 is a schematic cross-sectional view showing a lithium-ion secondary battery according to an embodiment of the present invention.

As shown in FIG. 2, the lithium-ion secondary battery 10 includes a solid electrolyte 11, a positive electrode 12, and a negative electrode 13. The solid electrolyte 11 has a first principal surface 11a and a second principal surface 11b opposed to each other. The solid electrolyte 11 is made of a solid electrolyte containing the above-described titanic acid-based solid electrolyte material according to the present invention. The positive electrode 12 is laid on the first principal surface 11a of the solid electrolyte 11. The negative electrode 13 is laid on the second principal surface 11b of the solid electrolyte 11.

The method for producing the battery according to the present invention is not particularly limited so long as it is a method that can provide the above-described battery, and the same method as any known battery production method can be used. An example is a production method of sequentially laying and pressing a positive electrode, a solid electrolyte, and a negative electrode one on top of another to make an electric-generating element, enclosing the electric-generating element in a battery case, and swaging the battery case.

Any general battery case can be used as the battery case for use in the battery according to the present invention. An example of the battery case is a battery case made of stainless steel.

Since the solid electrolyte according to the present invention is disposed in the battery according to the present invention, the battery is free from risk of production of hydrogen sulfide and therefore has excellent safety. Because of high lithium-ion conductivity of the solid electrolyte, a high-power battery can be achieved using the solid electrolyte. In addition, since the solid electrolyte is disposed in the battery, it also serves as a separation film and eliminates the need for an existing separation film and, therefore, thickness reduction of the battery can be expected.

Hereinafter, a description will be given of components of the battery according to the present invention.

(Positive Electrode)

The positive electrode forming part of the battery according to the present invention includes a positive-electrode current collector and a positive-electrode active material layer.

Examples of the material for the positive-electrode current collector include copper, nickel, stainless steel, iron, titanium, aluminum, and aluminum alloy and the preferred material is aluminum. The thickness and shape of the positive-electrode current collector can be appropriately selected according to the usage and so on of the battery and, for example, the positive-electrode current collector may have the shape of a planar strip. In the case of a strip-shaped positive-electrode current collector, it can have a first surface and a second surface as the side of the positive-electrode current collector opposite to the first surface. The positive-electrode active material layer can be formed on one or both surfaces of the positive-electrode current collector.

The positive-electrode active material layer is a layer containing a positive-electrode active material and may contain a conductive material and a binder as necessary. The positive-electrode active material layer may further contain the solid electrolyte material according to the present invention. When containing the solid electrolyte material according to the present invention, the positive-electrode active material layer can have higher lithium-ion conductivity. The thickness of the positive-electrode active material layer is preferably 0.1 μm to 1000 μm.

The positive-electrode active material is not limited so long as it can absorb and release lithium or lithium ions, and examples include lithium cobaltate (LiCoO₂), lithium nickelate (LiNiO₂), lithium manganate (LiMnO₂), lithium nickel cobalt aluminate (such as LiNi_{0.8}Co_{0.15}Al_{0.05}O₂), lithium nickel cobalt manganate (such as LiNi_{1/3}Mn_{1/3}Co_{1/3}O₂ or Li₁₊ₓNi_{1/3}Mn_{1/3}Co_{1/3} O₂ (0≤x<0.3)), spinel oxides (LiM₂O₄ where M=Mn, V), lithium metal phosphates (LiMPO₄ where M=Fe, Mn, Co, Ni), silicate oxides (Li₂MSiO₄ where M=Mn, Fe, Co, Ni), LiNi_{0.5}Mn_{1.5} O₄, and S₈.

The conductive material is mixed in order to increase the current collecting performance and reduce the contact resistance between the positive-electrode active material and the positive-electrode current collector and examples include carbon-based materials, such as vapor-grown carbon fibers (VGCF), coke, carbon black, acetylene black, Ketjenblack, graphite, carbon nanofibers, and carbon nanotubes.

The binder is mixed in order to fill voids in the dispersed positive-electrode active material and also bind the positive-electrode active material and the positive-electrode current collector together and examples thereof include: synthetic rubbers, such as polysiloxane, polyalkylene glycol, ethyl vinyl alcohol copolymer, carboxymethylcellulose (CMC), hydroxypropyl methylcellulose propyl (HPMC), cellulose acetate, polytetrafluoroethylene (PTFE), polyvinylidene fluoride (PVDF), polyvinylidene fluoride-hexafluoropropylene copolymer (PVDF-HFP), butadiene rubber, styrene-butadiene rubber (SBR), styrene-butadiene-styrene copolymer (SBS), styrene-ethylene-butadiene-styrene copolymer (SEBS), ethylene-propylene rubber, butyl rubber, chloroprene rubber, acrylonitrile-butadiene rubber, acrylic rubber, silicone rubber, fluororubber, and urethane rubber; polyimide; polyamide; polyamide imide; polyvinyl alcohol; and chlorinated polyethylene (CPE).

In an example of a method for producing a positive electrode, a positive-electrode active material, a conductive material, and a binder are suspended in a solvent to prepare a slurry and the slurry is applied to one surface or both surfaces of a positive-electrode current collector. Next, the applied slurry is dried to obtain a laminate of a positive-electrode active material-containing layer and the positive-electrode current collector. Thereafter, in the method, the laminate is pressed. In another method, a positive-electrode active material, a conductive material, and a binder are mixed and the resultant mixture is molded into pellets. Next, in the method, these pellets are disposed on a positive-electrode current collector.

(Negative Electrode)

The negative electrode forming part of the battery according to the present invention includes a negative-electrode current collector and a negative-electrode active material layer.

Examples of the material for the negative-electrode current collector include stainless steel, copper, nickel, and carbon and the preferred material is copper. The thickness and shape of the negative-electrode current collector can be appropriately selected according to the usage and so on of the battery and, for example, the negative-electrode current collector may have the shape of a planar strip. In the case of a strip-shaped current collector, it can have a first surface and a second surface as the side of the current collector opposite to the first surface. The negative-electrode active material layer can be formed on one or both surfaces of the negative-electrode current collector.

The negative-electrode active material layer is a layer containing a negative-electrode active material and may contain a conductive material and a binder as necessary. The negative-electrode active material layer may further contain the solid electrolyte material according to the present invention. When containing the solid electrolyte material according to the present invention, the negative-electrode active material layer can have higher lithium-ion conductivity. The thickness of the negative-electrode active material layer is preferably 0.1 μm to 1000 μm.

Examples of the material for the negative-electrode active material include metal active materials, carbon active materials, lithiummetal, oxides, nitrides, and mixtures of them. The metal active materials include In, Al, Si, and Sn. The carbon active materials include mesocarbon microbeads (MCMB), highly oriented graphite (HOPG), hard carbon, and soft carbon. An example of the oxides is Li₄Ti₅O₁₂. An example of the nitrides is LiCoN.

The conductive material is mixed in order to increase the current collecting performance and reduce the contact resistance between the negative-electrode active material and the negative-electrode current collector and examples include carbon-based materials, such as vapor-grown carbon fibers (VGCF), coke, carbon black, acetylene black, Ketjenblack, graphite, carbon nanofibers, and carbon nanotubes.

The binder is mixed in order to fill voids in the dispersed negative-electrode active material and also bind the negative-electrode active material and the negative-electrode current collector together and examples thereof include: synthetic rubbers, such as polysiloxane, polyalkylene glycol, polyacrylic acid, carboxymethylcellulose (CMC), hydroxypropyl methylcellulose propyl (HPMC), cellulose acetate, polytetrafluoroethylene (PTFE), polyvinylidene fluoride (PVDF), polyvinylidene fluoride-hexafluoropropylene copolymer (PVDF-HFP), butadiene rubber, styrene-butadiene rubber (SBR), styrene-butadiene-styrene copolymer (SBS), styrene-ethylene-butadiene-styrene copolymer (SEBS), ethylene-propylene rubber, butyl rubber, chloroprene rubber, acrylonitrile-butadiene rubber, acrylic rubber, silicone rubber, fluororubber, and urethane rubber; polyimide; polyamide; polyamide imide; polyvinyl alcohol; and chlorinated polyethylene (CPE).

In an example of a method for producing a negative electrode, a negative-electrode active material, a conductive material, and a binder are suspended in a solvent to prepare a slurry and the slurry is applied to one surface or both surfaces of a negative-electrode current collector. Next, the applied slurry is dried to obtain a laminate of a negative-electrode active material-containing layer and the negative-electrode current collector. Thereafter, in the method, the laminate is pressed. In another method, a negative-electrode active material, a conductive material, and a binder are mixed and the resultant mixture is molded into pellets. Next, in the method, these pellets are disposed on a negative-electrode current collector.

### EXAMPLES

The present invention will be described below in further detail with reference to specific examples. The present invention is not at all limited by the following examples and modifications and variations may be appropriately made therein without changing the gist of the invention.

Source titanates used in Examples and Comparative Example and the resultant powders were measured in terms of average particle diameter with a laser diffraction particle size distribution measurement device (SALD-2100 manufactured by Shimadzu Corporation) and confirmed in terms of interlayer distance by analysis with an X-ray diffraction measurement device (Ultima IV manufactured by Rigaku Corporation). Furthermore, the composition formulae were confirmed with an ICP-AES analyzer (SPS5100 manufactured by SII Nano Technology Inc.) and a thermogravimetric apparatus (EXSTAR6000 TG/DTA6300, manufactured by SII Nano Technology Inc.).

<Source Titanate>

The source titanates used in Examples and Comparative Example are as follows.

(Source Titanate A)

A lepidocrocite potassium lithium titanate (K_{0.6}Li_{0.27}Ti_{1.73}O_{3.9}) containing potassium ions in the interlayers and lithium ions in the host layers was used as source titanate A. The lepidocrocite potassium lithium titanate had an average particle diameter of 3 μm, was white powder made of platy particles, and had an interlayer distance of 7.8 Å.

(Source Titanate B)

A lepidocrocite potassium magnesium titanate (K_{0.6}Mg_{0.4}Ti_{1.6}O_{3.9}) containing potassium ions in the interlayers and magnesium ions in the host layers was used as source titanate B. The lepidocrocite potassium magnesium titanate had an average particle diameter of 5 μm, was white powder made of platy particles, and had an interlayer distance of 7.8 Å.

### Example 1

An amount of 65 g of source titanate A was dispersed into 1 kg of deionized water and 50.4 g of 95% sulfuric acid was added to the liquid. The mixed liquid was stirred for an hour and then subjected to separation and the separated product was washed with water. This operation was repeated twice, thus obtaining a lepidocrocite titanic acid in which some of potassium ions and some of lithium ions in the source titanate were exchanged for hydrogen ions or hydronium ions. An amount of 50 g of the lepidocrocite titanic acid was dispersed into 200 g of deionized water and 324 g of 10% aqueous solution of lithium hydroxide monohydrate was added to the liquid with heating to 70° C. and stirring. The liquid was stirred at 70° C. for three hours and then a residue was filtered out. The residue was well washed with hot water at 70° C. and then dried in air at 110° C. for 12 hours, thus obtaining a powdered lepidocrocite titanate.

The average particle diameter, interlayer distance, and composition formula of the obtained lepidocrocite titanate was 3 μm, 8.4 Å, and K_{0.07} Li_{1.0} Ti_{1.73}O₄·0.97H₂O, respectively.

### Example 2

The lepidocrocite titanate produced in Example 1 was heated at 300° C. for an hour, thus obtaining a powdered lepidocrocite titanate.

The average particle diameter, interlayer distance, and composition formula of the obtained lepidocrocite titanate was 3 μm, 7.0 Å, and K_{0.07} Li_{1.0} Ti_{1.73}O₄·0.21H₂O, respectively.

### Example 3

An amount of 130 g of source titanate B was dispersed into 1.8 kg of deionized water and 230.4 g of phosphoric acid was added to the liquid. The mixed liquid was stirred for an hour and then subjected to separation and the separated product was washed with water, thus obtaining a lepidocrocite titanic acid in which some of potassium ions and some of magnesium ions in the source titanate were exchanged for hydrogen ions or hydronium ions. The lepidocrocite titanic acid was dispersed into 834 g of 10% aqueous solution of lithium hydroxide monohydrate and the liquid was heated to 70° C. and stirred. The liquid was stirred at 70° C. for three hours and then a residue was filtered out. The residue was well washed with hot water at 70° C. and then dried in air at 110° C. for 12 hours, thus obtaining a powdered lepidocrocite titanate.

The average particle diameter, interlayer distance, and composition formula of the obtained lepidocrocite titanate was 4 μm, 8.4 Å, and K_{0.05}Li_{1.0}Mg_{0.3}Ti_{1.6}O₄·1.1H₂O, respectively.

### Example 4

An amount of 6.0 g of source titanate A and 46 g of lithium nitrate were mixed and the mixture was heated at 260° C. for 48 hours. The sample after the heating was washed with water and dried at 110° C. for 12 hours, thus obtaining a powdered lepidocrocite titanate.

The average particle diameter, interlayer distance, and composition formula of the obtained lepidocrocite titanate was 3 μm, 6.5 Å, and K_{0.09}Li_{0.9}Ti_{1.73} O₄·0.13H₂O, respectively.

### Example 5

An amount of 15 g of source titanate A was dispersed into 220 g of deionized water and 11.7 g of 95% sulfuric acid was added to the liquid. The mixed liquid was stirred for an hour and then subjected to separation and the separated product was washed with water. This operation was repeated twice, thus obtaining a lepidocrocite titanic acid in which some of potassium ions and some of lithium ions in the source titanate were exchanged for hydrogen ions or hydronium ions. An amount of 5 g of the lepidocrocite titanic acid was dispersed into 142.5 g of deionized water and 0.61 g of sodium hydroxide and 1.17 g of lithium hydroxide monohydrate were added to the liquid with heating to 40° C. and stirring. The liquid was stirred at 40° C. for three hours and then a residue was filtered out. The residue was well washed and then dried in air at 110° C. for 12 hours, thus obtaining a powdered lepidocrocite titanate.

The average particle diameter, interlayer distance, and composition formula of the obtained lepidocrocite titanate was 2 μm, 8.7 Å, and K_{0.08}Na_{0.28}Li_{0.34}Ti_{1.73}O_{3.8}·1.0H₂O, respectively.

### Example 6

An amount of 15 g of source titanate A was dispersed into 220 g of deionized water and 11.7 g of 95% sulfuric acid was added to the liquid. The mixed liquid was stirred for an hour and then subjected to separation and the separated product was washed with water. This operation was repeated twice, thus obtaining a lepidocrocite titanic acid in which some of potassium ions and some of lithium ions in the source titanate were exchanged for hydrogen ions or hydronium ions. An amount of 5 g of the lepidocrocite titanic acid was dispersed into 142.5 g of deionized water and 0.81 g of potassium hydroxide and 1.17 g of lithium hydroxide monohydrate were added to the liquid with heating to 40° C. and stirring. The liquid was stirred at 40° C. for three hours and then a residue was filtered out. The residue was well washed and then dried in air at 110° C. for 12 hours, thus obtaining a powdered lepidocrocite titanate.

The average particle diameter, interlayer distance, and composition formula of the obtained lepidocrocite titanate was 2 μm, 8.6 Å, and K_{0.30}Li_{0.43}Ti_{1.73}O_{3.8}·0.84H₂O, respectively.

### Comparative Example 1

A product Li_{0.33}La_{0.55}TiO₃ (cubic) (LLTO) was used as a comparative example. The average particle diameter was 5 μm.

<Measurement of Impedance>

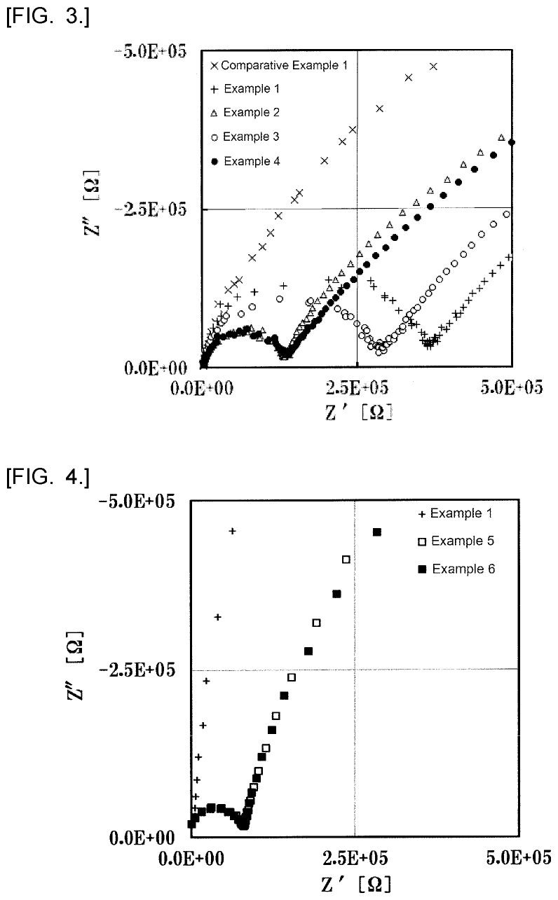

Each of samples of the lepidocrocite titanates obtained in Examples 1 to 4 and a sample of LLTO in Comparative Example 1 was put into a container made of Teflon (registered trademark) and having 0.8 cm diameter copper electrodes at both ends and measured in terms of impedance in a range of 1 MHz to 1 Hz by the AC impedance method while a load of 350 kg/cm² was applied to the sample to give the sample a thickness of 0.04 cm (measurement device: CompactStat manufactured by Ivium Technologies). FIG. 3 shows Nyquist diagrams.

An amount of 0.050 g of each of samples of the lepidocrocite titanates obtained in Examples 1, 5, and 6 was put into a container made of Teflon (registered trademark) and having 0.8 cm diameter copper electrodes at both ends and measured in terms of impedance in a range of 1 MHz to 70 Hz by the AC impedance method while a load was applied to the sample to give the sample a thickness of 1.0 mm (measurement device: CompactStat manufactured by Ivium Technologies). FIG. 4 shows Nyquist diagrams.

The Nyquist diagrams show semicircular features at higher frequencies and spike features at shorter frequencies and it can be considered that the smaller the semicircle at higher frequencies, the more excellent the ionic conductivity. As shown in FIG. 3, the lepidocrocite titanates obtained in Examples 1 to 4 have smaller arcs than LLTO in Comparative Example 1, which shows that the lepidocrocite titanates in Examples 1 to 4 have excellent ionic conductivity. Furthermore, as shown in FIG. 4 which shows results measured under stricter conditions than in FIG. 3, the lepidocrocite titanates obtained in Examples 5 and 6 have smaller arcs than that obtained in Example 1, which shows that they have more excellent ionic conductivity because not only lithium ions but also sodium ions or potassium ions are intercalated in the interlayers between the host layers.

### REFERENCE SIGNS LIST

1 . . . titanic acid-based solid electrolyte material
2 . . . host layer
3 . . . ion
10 . . . lithium-ion secondary battery
11 . . . solid electrolyte
11a . . . first principal surface
11b . . . second principal surface
12 . . . positive electrode
13 . . . negative electrode

1. A titanic acid-based solid electrolyte material made of a lepidocrocite titanate having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by cations with valences of +1 to +3.

2. The titanic acid-based solid electrolyte material according to claim 1, wherein an interlayer distance between the host layers is not less than 5 Å and not more than 10 Å.

3. The titanic acid-based solid electrolyte material according to claim 1, wherein the lepidocrocite titanate contains crystallization water.

4. The titanic acid-based solid electrolyte material according to claim 1, wherein a content of the lithium ions present in the interlayers between the host layers is not less than 45% by mole and not more than 100% by mole relative to 100% by mole of ions present in the interlayers between the host layers.

5. The titanic acid-based solid electrolyte material according to claim 1, being at least one of a compound represented by general formula (1) below and a compound represented by general formula (2) below:
LiₓM^{I}_{y}Ti_{1.73}O_{3.7-4}·nH₂O Formula (1)
where M^{I} represents an alkali metal except for lithium, the index x is 0.3 to 1.0, the index y is 0 to 0.4, and the index n is 0 to 2; and
LiₓM^{I}_{y}M^{II}_{z}Ti_{1.6}O_{3.7-4}·nH₂O Formula (2)
where M^{I} represents an alkali metal except for lithium, M^{II} represents an alkaline earth metal, the index x is 0.3 to 1.0, the index y is 0 to 0.4, the index z is 0 to 0.4, and the index n is 0 to 2.

6. A method for producing the titanic acid-based solid electrolyte material according to claim 1, the method comprising the step of subjecting a lepidocrocite titanate and a lithium salt to mixing and heat treatment.

7. A method for producing the titanic acid-based solid electrolyte material according to claim 1, the method comprising the steps of:
mixing a lepidocrocite titanate and an acid to prepare a lepidocrocite titanic acid; and
mixing the lepidocrocite titanic acid and a lithium salt.

8. A solid electrolyte containing the titanic acid-based solid electrolyte material according to claim 1.

9. A lithium-ion secondary battery comprising the solid electrolyte according to claim 8.
